(19) United States
(12) Patent Application Publication
(10) Pub. No.: US 2018/0310593 A1
(43) Pub. Date: Nov. 1, 2018

(54) FISHING BAIT PREPARED FROM FARM MORTALITY

(71) Applicant: GSL Holdings LLC, Millsboro, DE (US)

(72) Inventors: Todd Victor Clark, Wilmington, DE (US); Paul Terrance Baker, Millsboro, DE (US)

(73) Assignee: GSL Holdings LLC, Millsboro, DE (US)

(21) Appl. No.: 15/963,511

(22) Filed: Apr. 26, 2018

Related U.S. Application Data
(60) Provisional application No. 62/490,195, filed on Apr. 26, 2017.

(51) Int. Cl. A23K 10/26; A01K 79/02; A23K 50/80

(52) U.S. Cl. CPC A23K 10/26; A23K 50/80; A01K 79/02

(57) ABSTRACT

Provided herein are compositions that are useful for attracting fish, conch, crustaceans, or any combination thereof. Also provided herein are processes of preparing the compositions, methods of using the compositions for improving the biosecurity of an environment, and methods of using the composition for attracting fish, conch, crustaceans, or any combination thereof.

### CROSS-REFERENCE TO RELATED APPLICATIONS

This application claims the benefit of U.S. Provisional Application Ser. No. 62/490,195, filed Apr. 26, 2017, the disclosure of which is incorporated herein by reference in its entirety.

### TECHNICAL FIELD

Provided herein are compositions comprising a farm mortality protein source that are useful, for example, as fish bait compositions. Also provided herein are processes of preparing the compositions and methods of using the compositions.

### BACKGROUND

Aquatic life (e.g., fish, conch, crustaceans, and the like) which are attracted to their respective food stuffs by a sense of smell (i.e., olfactory stimulation), generally exhibit sensitive and developed olfactory senses. These species generally include bottom feeders and scavengers with poor visual capacity. The odors produced by a naturally occurring food source, such as decomposing flesh, provide an olfactory stimulation that attracts various species of fish and crustaceans.

### SUMMARY

The present application provides, inter alia, compositions comprising a farm mortality protein source (e.g. a farm mortality farm animal) as described herein.

The present application further provides compositions comprising about 50% to about 100% by weight of a farm mortality protein source; about 0% to about 50% by weight of an additional protein source about 0% to about 5% by weight of a preservative; about 0% to about 5% by weight of a binding agent; about 0% to about 5% by weight of an attractant; and about 0% to about 5% by weight of a pH balancing agent.

The present application further provides processes of preparing compositions provided herein, comprising grinding the farm mortality protein source (e.g., a farm mortality farm animal) in a grinding apparatus to form a ground farm mortality protein source (e.g. a ground farm mortality farm animal), thereby forming a composition provided herein.

The present application further provides processes comprising:

i) freezing a farm mortality animal in a freezer apparatus; and

ii) grinding the farm mortality animal in a grinding apparatus to form a ground farm mortality animal, thereby forming a composition provided herein.

The present application further provides methods of improving biosecurity on a farm, comprising:

i) freezing poultry farm mortality in a freezer located at the farm;

ii) transporting the frozen poultry farm mortality from the farm to a processing center; and

iii) grinding the poultry farm mortality in a grinding apparatus at the processing center to form a composition provided herein, thereby improving the biosecurity of the farm.

The present application further provides a method of attracting a fish, a conch, a crustacean, or any combination thereof, comprising contacting a composition provided herein with a body of water containing said fish, conch, crustacean, or any combination thereof.

Unless otherwise defined, all technical and scientific terms used herein have the same meaning as commonly understood by one of ordinary skill in the art to which this invention belongs. Methods and materials are described herein for use in the present invention; other, suitable methods and materials known in the art also can be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF DRAWINGS

FIGS. 1A-1B show representative bait compositions encased in a sausage casing (FIG. 1A) and further encased in vacuum sealed packaging (FIG. 1B).

FIGS. 2-3 show representative fishing traps useful for catching conch.

FIG. 4 shows a representative fishing trap (i.e., a fishing pot) useful for catching crab.

FIGS. 5A-5B show representative fishing traps useful for catching eel.

FIG. 6 shows a representative bait bag useful for catching crab (e.g., blue crab) with a trot line. The fishing bait is enclosed within the mesh bag that can be attached to the line.

### DETAILED DESCRIPTION

The present application generally provides compositions useful as bait for attracting aquatic life (e.g., fish, conch, crustaceans, or a combination thereof). The compositions described herein provide unique and unexpected benefits when used as bait.

The use of farm mortality, in particular, greatly improves the effectiveness of the bait compositions described herein. The chemo-attractants naturally generated and released during decomposition are highly attractive to aquatic life dependent upon olfactory stimulation for locating food. Alternative protein sources, such as byproducts of animals killed at processing plants, do not go through the decomposition process, and therefore, do not produce the chemo-attractants that are a critical component to the efficacy of the bait compositions described herein.

The processes described herein to prepare the compositions discussed herein also provide unique and unexpected benefits. A natural binding agent, for example, is formed as a byproduct of grinding the feathers and bones when processing whole carcass poultry mortality—a benefit that is not easily replicated using byproducts of poultry processing plants. This benefit reduces the need for additional binding agents, thereby lowering the cost of manufacturing the compositions provided herein.

Moreover, the processes used to prepare the compositions described herein do not require any pre-processing (e.g., butchering, de-feathering, skinning, cooking, rendering), further minimizing manufacturing cost and waste. An entire farm mortality animal can be ground into an essentially homogenous composition, which can be directly extruded into a suitable container.

In addition, the processes described herein to prepare the compositions improve biosecurity of farms that switch from open-air composting of routine farm mortality to storing mortality inside sealed containers such as freezers units. In doing so, the farm will be less attractive to disease carrying scavengers and insects, thereby improving the biosecurity of the farm and the quality of life for farmers and their neighbors. The improved biosecurity on the subject farm also may protect neighboring farm operations by reducing the opportunity for wider outbreaks of disease.

The processes described herein to prepare the compositions also can reduce the operational costs and improve working conditions for farms that switch from traditional composting methods, which require substantial labor and materials, to storing farm mortality in container units (e.g., freezer units).

The compositions and methods provided herein also provide a reduced environmental impact for farms that switch from traditional composting of routine farm mortality, which necessarily requires subsequent land application of the resulting high phosphorous material, to storing mortality inside container units, which is later recycled by a third party.

The compositions provided herein also provide reduced operational costs for commercial fishermen, as the compositions provided herein can be prepared using fewer components and can provide catch sizes which are equal to or larger than the catch sizes that have been acquired using standard fishing baits for the same fisheries. In addition, the farm mortality can often be sourced locally to a fishery, thereby further reducing transportation costs.

Further, the compositions and methods described herein provide a reduced procurement time of the bait, particularly for commercial watermen who operate using less abundant or less readily available traditional or alternative baits. This aspect may extend fishing seasons by providing improved access to fishing bait compositions compared to traditional baits which may have limited availability.

The compositions, processes, and kits provided herein further reduce preparation work for commercial watermen. Traditional baits generally require cumbersome storage and/or transportation methods (e.g., thawing and then breaking a previously frozen block of bait fish).

### Definitions

Unless defined otherwise, all technical and scientific terms used herein have the same meaning as is commonly understood by one of ordinary skill in the art to which this disclosure belongs, taking into account the context provided by the present disclosure.

For the terms “e.g.” and “such as,” and grammatical equivalents thereof, the phrase “and without limitation” is understood to follow unless explicitly stated otherwise.

The singular forms “a,” “an,” and “the” include plural referents unless the context clearly dictates otherwise.

As used herein, the term “about” means “approximately” (e.g., plus or minus approximately 10% of the indicated value).

As used herein, the term “room temperature” refers generally to a temperature that is about the temperature of the room in which a process is carried out, e.g., a temperature from about 20° C. to about 30° C., typically about 25° C.

The term “contacting” means bringing at least two moieties together.

As used herein, the term “farm mortality” refers to a farm animal (e.g., a chicken, cow, or pig), which has died on a farm due to routine natural causes (e.g., organ failure, illness, and the like), as opposed to catastrophic disease outbreaks (e.g., avian influenza, mad cow disease, swine influenza, and the like.

As used herein, the term “dead-on-arrival” or “DOA” refers to a farm animal (e.g., a chicken, cow, or pig), which has died during transportation from the farm) to a plant for processing the protein sources into products for human consumption.

### Composition

The present application provides, inter alia, a composition comprising a farm mortality protein source (e.g., poultry farm mortality, beef farm mortality, swine farm mortality, or any combination thereof) useful as a bait for fishing and/or attracting aquatic life. It is understood that while the compositions provided herein may, for example, comprise one or more naturally occurring components, the compositions of the present invention are not naturally occurring. In some embodiments, the compositions provided herein have been prepared according to one or more of the processes described herein. In some embodiments, the composition further comprises an additional protein source, a preservative, a binding agent, an attractant, a pH balancing agent, or any combination thereof. In some embodiments, the composition further comprises a preservative. In some embodiments, the composition further comprises a binding agent. In some embodiments, the composition further comprises an attractant. In some embodiments, the composition further comprises a pH balancing agent. In some embodiments, the composition further comprises an additional protein source.

In some embodiments, the composition comprises greater than about 75% by weight of a farm mortality protein source, for example, greater than about 80%, greater than about 90%, greater than about 95%, greater than about 96%, greater than about 97%, greater than about 98%, greater than about 99%, greater than about 99.1%, greater than about 99.2%, greater than about 99.3%, greater than about 99.4%, greater than about 99.5%, greater than about 99.6%, greater than about 99.7%, greater than about 99.8%, or greater than about 99.9%.

In some embodiments, the composition comprises from about 0% to about 100% by weight of a farm mortality protein source, for example, about 0.1% to about 100%, about 0.1% to about 95%, about 0.1% to about 90%, about 0.1% to about 80%, about 0.1% to about 70%, about 0.1% to about 60%, about 0.1% to about 50%, about 0.1% to about 40%, about 0.1% to about 30%, about 0.1% to about 20%, about 0.1% to about 10%, about 10% to about 100%, about 10% to about 95%, about 10% to about 90%, about 10% to about 80%, about 10% to about 70%, about 10% to about 60%, about 10% to about 50%, about 10% to about 40%, about 10% to about 30%, about 10% to about 20%, about 20% to about 100%, about 20% to about 95%, about 20% to about 90%, about 20% to about 80%, about 20% to about 70%, about 20% to about 60%, about 20% to about 50%, about 20% to about 40%, about 20% to about 30%, about 30% to about 100%, about 30% to about 95%, about 30% to about 90%, about 30% to about 80%, about 30% to about 70%, about 30% to about 60%, about 30% to about 50%, about 30% to about 40%, about 40% to about 100%, about 40% to about 95%, about 40% to about 90%, about 40% to about 80%, about 40% to about 70%, about 40% to about 60%, about 40% to about 50%, about 50% to about 100%, about 50% to about 95%, about 50% to about 90%, about 50% to about 80%, about 50% to about 70%, about 50% to about 60%, about 60% to about 100%, about 60% to about 95%, about 60% to about 90%, about 60% to about 80%, about 60% to about 70%, about 70% to about 100%, about 70% to about 95%, about 70% to about 90%, about 70% to about 80%, about 80% to about 100%, about 80% to about 95%, about 80% to about 90%, about 90% to about 100%, about 90% to about 95%, or about 95% to about 100% by weight of the composition. In some embodiments, the composition comprises about 75% to about 100% of a farm mortality protein source.

In some embodiments, the composition comprises about 90% to about 100% by weight of a farm mortality protein source. In some embodiments, the composition comprises about 90% to about 99.9% by weight of a farm mortality protein source. In some embodiments, the composition comprises about 90% to about 95% by weight of a farm mortality protein source. In some embodiments, the composition comprises about 95% to about 100% by weight of a farm mortality protein source. In some embodiments, the composition comprises about 95% to about 99.9% by weight of a farm mortality protein source.

In some embodiments, the farm mortality protein source is selected from the group consisting of poultry farm mortality, beef farm mortality, swine farm mortality, or any combination thereof. In some embodiments, the protein source is a ground farm mortality protein source (e.g., ground poultry farm mortality, for example, ground chicken farm mortality, ground turkey farm mortality, and the like). In some embodiments, the farm mortality protein source comprises poultry farm mortality, for example, chicken farm mortality, turkey farm mortality, water-fowl farm mortality (e.g., duck, goose, and the like), or any combination thereof. In some embodiments, the farm mortality protein source comprises chicken farm mortality. In some embodiments, the farm mortality protein source comprises an entire farm animal (e.g., an entire chicken, including for example, feathers, bones, beak, muscles, organs, cartilage, tendons, ligaments, and the like).

In some embodiments, the farm mortality protein source comprises a ground farm mortality protein source (e.g., a farm mortality protein source which has been ground in a grinding process provided herein). In some embodiments, the ground farm mortality protein source comprises an entire farm animal (e.g., an entire ground chicken, including for example ground feathers, ground bones, ground beak, ground muscles, ground organs, ground cartilage, ground tendons, ground ligaments, and the like).

In some embodiments, the ground farm animal protein source is prepared using a grinding apparatus with a grinding cut of about 1 inch to about 2 inches. When ground in the grinding process as described herein, the ground farm mortality protein source more effectively releases chemo-attractants. When ground in a grinding process as described herein, the ground farm mortality protein source also forms a more effective bait with greater longevity in the water.

In some embodiments, the composition further comprises an additional protein source. In some embodiments, the protein source comprises a protein selected from the group consisting of poultry, beef, swine, a food processing by-product, grocery store by-product, restaurant by-product, or any combination thereof.

In some embodiments, the additional protein source comprises poultry, for example, chicken, turkey, water-fowl (e.g., duck, goose, and the like), or any combination thereof.

In some embodiments, the additional protein source comprises poultry which has not been plucked, skinned, de-feathered, de-boned, rendered, or any combination thereof. In some embodiments, the additional protein source comprises the entire poultry (e.g., the entire chicken, including for example, feathers, bones, beak, muscles, organs, cartilage, tendons, ligaments, and the like). In some embodiments, the additional protein source is a dead-on-arrival (i.e., DOA) farm animal.

In some embodiments, the additional protein source comprises an additional ground protein source (e.g., a protein source which has been ground in a grinding process provided herein).

In some embodiments, the additional ground protein source comprises ground poultry, ground beef, ground swine, a ground food processing by-product, a ground grocery store by-product, a ground restaurant by-product, or any combination thereof.

In some embodiments, the additional protein source comprises multiple proteins from different sources. By way of example, in some embodiments, the composition comprises protein from two or more sources selected from the group consisting of poultry, beef, swine, a food processing by-product, grocery store waste product, restaurant waste product, or any combination or subcombination thereof. In such compositions, the ratio of protein from each source may vary, for example, from about 1:99 to about 99:1 for a composition comprising two protein sources. Exemplary ratios for a composition comprising two protein sources (e.g., protein source A: protein source B) include, for example, about 1:99, about 5:95, about 10:90, about 20:80, about 10:90, about 30:70, about 40:60, about 50:50, about 60:40, about 70:30, about 80:20, about 90:10, about 95:5, and about 1:99.

In some embodiments, the composition comprises 1, 2, 3, 4, or 5 independently selected additional protein sources. In some embodiments, the composition comprises 1 or 2 independently selected additional protein sources. In some embodiments, the composition comprises one additional protein source.

In some embodiments, the composition comprises a preservative. When incorporated into the compositions provided herein, the preservative reduces and/or eliminates pathogens, bacteria, and/or other microorganisms that would otherwise cause the composition to decompose. For example, an organic acid preservative reduces the pH of the composition thereby reducing or eliminating pathogens, bacteria, and/or other microorganisms present in the composition. Thus, an organic acid preservative 1) renders the composition inert (i.e., uncontaminated by pathogens, bacteria, and/or other microorganisms) and/or 2) preserves the composition by reducing and/or eliminating pathogens, bacteria, and/or other microorganisms that would otherwise cause the composition to decompose.

In some embodiments, the composition comprises one or more independently selected preservatives. In some embodiments, the composition comprises 1, 2, 3, 4, or 5 independently selected preservatives. In some embodiments, the composition comprises 1 or 2 independently selected preservatives. In some embodiments, the composition comprises one preservative.

Preservatives useful in the compositions described herein include, but are not limited to, anti-microbial preservatives and antioxidant preservatives. Exemplary anti-microbial preservatives include, but are not limited to, benzoic acid (sodium benzoate), citric acid, hydroxybenzoate, lactic acid, nitrite salts, nitrate salts, propionic acid (sodium propionate), and the like. Exemplary antioxidant agents include, but are not limited to, ascorbic acid (sodium ascorbate), citric acid, butylated hydroxytoluene, butylated hydroxyanisole, gallic acid (sodium gallate), ethylenediaminetetraacetic acid, disodium ethylenediaminetetraacetate, calcium ethylenediaminetetraacetate, tartaric acid, lecithin, and the like.

In some embodiments, the composition comprises about 0.1% to about 80% of preservative, for example, about 0.1% to about 75%, about 0.1% to about 60%, about 0.1% to about 50%, about 0.1% to about 40%, about 0.1% to about 30%, about 0.1% to about 20%, about 0.1% to about 10%, 0.1% to about 1%, about 1% to about 75%, about 1% to about 60%, about 1% to about 50%, about 1% to about 40%, about 1% to about 30%, about 1% to about 20%, about 1% to about 10%, about 10% to about 75%, about 10% to about 60%, about 10% to about 50%, about 10% to about 40%, about 10% to about 30%, about 10% to about 20%, about 20% to about 75%, about 20% to about 60%, about 20% to about 50%, about 20% to about 40%, about 20% to about 30%, about 30% to about 75%, about 30% to about 60%, about 30% to about 50%, about 30% to about 40%, about 40% to about 75%, about 40% to about 60%, about 40% to about 50%, about 50% to about 75%, about 50% to about 60%, or about 60% to about 75% by weight of the composition. In some embodiments, the composition comprises about 0.1% to about 5% by weight of preservative.

In some embodiments, the composition comprises a preservative which is an organic acid preservative. Exemplary organic acid preservatives useful in the compositions described herein include, but are not limited to, ascorbic acid, formic acid, acetic acid, citric acid, lactic acid, benzoic acid, gallic acid, an amino acid (e.g., a natural amino acid or a synthetic amino acid), fumaric acid, malic acid, maleic acid, tartaric acid, and the like.

In some embodiments, the composition comprises one or more independently selected organic acids. In some embodiments, the composition comprises 1, 2, 3, 4, or 5 independently selected organic acids. In some embodiments, the composition comprises 1 or 2 independently selected organic acids. In some embodiments, the composition comprises one organic acid.

In some embodiments, the composition comprises about 0.1% to about 80% of organic acid, for example, about 0.1% to about 75%, about 0.1% to about 60%, about 0.1% to about 50%, about 0.1% to about 40%, about 0.1% to about 30%, about 0.1% to about 20%, about 0.1% to about 10%, 0.1% to about 1%, about 1% to about 75%, about 1% to about 60%, about 1% to about 50%, about 1% to about 40%, about 1% to about 30%, about 1% to about 20%, about 1% to about 10%, about 10% to about 75%, about 10% to about 60%, about 10% to about 50%, about 10% to about 40%, about 10% to about 30%, about 10% to about 20%, about 20% to about 75%, about 20% to about 60%, about 20% to about 50%, about 20% to about 40%, about 20% to about 30%, about 30% to about 75%, about 30% to about 60%, about 30% to about 50%, about 30% to about 40%, about 40% to about 75%, about 40% to about 60%, about 40% to about 50%, about 50% to about 75%, about 50% to about 60%, or about 60% to about 75% by weight of the composition. In some embodiments, the composition comprises about 0.1% to about 20% by weight of organic acid.

In some embodiments, the composition comprises a binding agent. In some embodiments, the composition comprises one or more binding agents. In some embodiments, the composition comprises 1, 2, 3, 4, or 5 independently selected binding agents. In some embodiments, the composition comprises 1 or 2 independently selected binding agents. In some embodiments, the composition comprises one binding agent.

In some embodiments, the composition comprises about 0.1% to about 80% of binding agent, for example, for example, about 0.1% to about 75%, about 0.1% to about 60%, about 0.1% to about 50%, about 0.1% to about 40%, about 0.1% to about 30%, about 0.1% to about 20%, about 0.1% to about 10%, 0.1% to about 1%, about 1% to about 75%, about 1% to about 60%, about 1% to about 50%, about 1% to about 40%, about 1% to about 30%, about 1% to about 20%, about 1% to about 10%, about 10% to about 75%, about 10% to about 60%, about 10% to about 50%, about 10% to about 40%, about 10% to about 30%, about 10% to about 20%, about 20% to about 75%, about 20% to about 60%, about 20% to about 50%, about 20% to about 40%, about 20% to about 30%, about 30% to about 75%, about 30% to about 60%, about 30% to about 50%, about 30% to about 40%, about 40% to about 75%, about 40% to about 60%, about 40% to about 50%, about 50% to about 75%, about 50% to about 60%, or about 60% to about 75% by weight of the composition. In some embodiments, the composition comprises about 0.1% to about 5% by weight of binding agent.

Examples of binding agents useful in the present invention include, but are not limited to, gums (e.g., xanthan gum, Gum Arabic, guar gum, karaya gum, tragacanth gum, and the like), waxes (e.g, candelilla wax), starches, eggs, and the like.

In some embodiments, the composition comprises an attractant (e.g., chemo-attractant, visual attractant, or any combination thereof). As used herein, chemo-attractants refer to compounds that stimulate movement toward the compound (and thus, the compositions provided herein) via chemical stimulus. Exemplary chemo-attractants include, but are not limited to, pheromones, biogenic polyamines (e.g., putrescine, cadaverine, spermidine) amino acids (e.g., taurine, arginine, ornithine, lysine, glycine), enzymatic proteins (e.g., adolase and trypsinogen), and the like. The chemo-attractant may be incorporated into the compositions provided herein as a liquid component, a solid component, a gel component, and the like. Additional attractants useful in the present invention include, but are not limited to, bait fish such as horseshoe crab, menhaden, herring, eel, razor clam, and the like, waste from seafood processing operations, powdered bone meal, powdered food solids, powdered anise, rhodinyl acetate, dehydrated fish meal, dried slaughterhouse waste products, powdered fish, egg, dried milk products, sodium chloride, molasses, fish powders and synthetic spices having a smell similar to that of fish meal, fish oil, stale fish, and/or shell fish, krill powder, sardine, yeast (e.g., inactivated and/or autolyzed yeast), squid, borax, wood flour, bentonite, pulp fiber, and cellulosic material. Additional attractants useful in the present application may be found, for example, in U.S. Pat. Nos. 4,245,420; 4,826,691; and U.S. Pat. No. 5,089,277; Hara et al, Fish Physiology, 1971, 5:79-120; Hara et al, Progress in Neurobiology, 1975, 5(4):271-335; Hara, Toshiaki J. (Ed.), “Chemoreception in Fishes”, Developments in Aquaculture and Fisheries Science, 1982, 8, Elsevier Scientific Publishing Co; and Pitcher, Tony J. (Ed.), “The Role of Olfaction in Fish Behavior”, The Behavior of Teleost Fishes, 1986, pp. 152-176, The Johns Hopkins University Press, the disclosures of each of which are incorporated herein by reference in their entireties.

As used herein, visual attractants include objects (e.g., lures) used to visually stimulate and attract movement toward the attractant (and thus, the compositions provided herein). Numerous visual attractants are known in the art and one of ordinary skill in the art would recognize an appropriate visual attractant useful for attracting a specific species of fish for use in combination with the compositions provided herein. In some embodiments, the visual attractant is useful for attracting bottom feeder fish.

In some embodiments, the attractant is incorporated into the composition (e.g., the attractant is mixed into the composition). In some embodiments, the attractant is physically attached to the composition, an outer casing of the composition, or a fishing trap in which the composition is enclosed.

In some embodiments, the attractant is selected from the group consisting of horseshoe crab, menhaden, herring, eel, razor clam, or any combination thereof.

In some embodiments, the composition comprises one or more attractants. In some embodiments, the composition comprises 1, 2, 3, 4, or 5 independently selected attractants. In some embodiments, the composition comprises 1 or 2 independently selected attractants. In some embodiments, the composition comprises one attractant.

In some embodiments, the composition comprises about 0.1% to about 80% by weight of attractant, for example, about 0.1% to about 75%, about 0.1% to about 60%, about 0.1% to about 50%, about 0.1% to about 40%, about 0.1% to about 30%, about 0.1% to about 20%, about 0.1% to about 10%, 0.1% to about 1%, about 1% to about 75%, about 1% to about 60%, about 1% to about 50%, about 1% to about 40%, about 1% to about 30%, about 1% to about 20%, about 1% to about 10%, about 10% to about 75%, about 10% to about 60%, about 10% to about 50%, about 10% to about 40%, about 10% to about 30%, about 10% to about 20%, about 20% to about 75%, about 20% to about 60%, about 20% to about 50%, about 20% to about 40%, about 20% to about 30%, about 30% to about 75%, about 30% to about 60%, about 30% to about 50%, about 30% to about 40%, about 40% to about 75%, about 40% to about 60%, about 40% to about 50%, about 50% to about 75%, about 50% to about 60%, or about 60% to about 75% by weight of the composition. In some embodiments, the composition comprises about 0.1% to about 5% by weight of attractant.

In some embodiments, the composition further comprises a pH balancing agent. As used herein, the term “pH balancing” agent refers to any compound (e.g., an acid or a base) useful for adjusting the pH of a composition to a specific value (e.g., 7, 8, 9, etc) or a specific range (e.g., pH=about 5 to about 7, about 7 to about 9, and the like).

In some embodiments, the pH balancing agent is added to the composition in an amount effective to adjust the pH level of the composition to about 7 or greater, for example, about 7, about 8, about 9, about 10, about 11, about 12, about 13, or about 14. In some embodiments, the pH balancing agent is added to the composition in an amount effective to adjust the pH level of the composition to about 7 to about 10.

In some embodiments, the pH balancing agent is added to the composition in an amount effective to adjust the pH level of the composition to about 7 or less, for example, about 7, about 6, about 5, about 4, about 3, about 2, or about 1. In some embodiments, the pH balancing agent is added to the composition in an amount effective to adjust the pH level of the composition to about 5 to about 7.

Exemplary pH balancing agents include, but are not limited to, ammonium aluminum sulfate, ammonium bicarbonate, ammonium carbonate, ammonium citrate dibasic, ammonium citrate monobasic, ammonium hydroxide, ammonium phosphate dibasic, ammonium phosphate monobasic, calcium acetate, calcium acid pyrophosphate, calcium carbonate, calcium chloride, calcium citrate, calcium fumarate, calcium Gluconate, calcium Hydroxide, calcium Lactate, calcium oxide, calcium phosphate dibasic, calcium phosphate monobasic, calcium phosphate tribasic, calcium sulfate, cream of tartar, glucono-delta-lactone, magnesium carbonate, magnesium citrate, magnesium fumarate, magnesium hydroxide, magnesium oxide, magnesium phosphate, magnesium sulfate, manganese sulfate, potassium acid tartrate, potassium aluminum sulfate, potassium bicarbonate, potassium carbonate, potassium chloride, potassium citrate, potassium fumarate, potassium hydroxide, potassium lactate, potassium phosphate dibasic, potassium phosphate tribasic, potassium sulfate, potassium tartrate, potassium tripolyphosphate, sodium acetate, sodium acid pyrophosphate, sodium acid tartrate, sodium aluminum phosphate, sodium aluminum sulfate, sodium bicarbonate, sodium bisulphate, sodium carbonate, sodium citrate, sodium fumarate, sodium gluconate, sodium hexametaphosphate, sodium hydroxide, sodium lactate, sodium phosphate dibasic, sodium phosphate monobasic, sodium phosphate tribasic, sodium potassium hexametaphosphate, sodium potassium tartrate, sodium potassium tripolyphosphate, sodium pyrophosphate tetrabasic, and sodium tripolyphosphate.

In some embodiments, the present application provides a composition comprising:

about 50% to about 100% by weight of a farm mortality protein source;

about 0% to about 50% by weight of an additional protein source;

about 0% to about 5% by weight of a preservative;

about 0% to about 5% by weight of a binding agent;

about 0% to about 5% by weight of an attractant; and

about 0% to about 5% by weight of a pH balancing agent.

### Process of Preparing the Compositions

The present application further provides a process of preparing a composition provided herein, comprising:

i) grinding the protein source in a grinding apparatus to form a ground protein source, thereby forming the composition.

In some embodiments, the process further comprises:

ii) mixing the ground protein source with a preservative, a binding agent, an attractant, a pH balancing agent, an additional protein source, or any combination thereof, thereby forming the composition.

In some embodiments, the grinding is performed for about 5 seconds to about 30 minutes, for example, about 5 seconds to about 25 minutes, about 5 seconds to about 20 minutes, about 5 seconds to about 10 minutes, about 5 seconds to about 5 minutes, about 5 seconds to about 1 minute, about 5 seconds to about 30 seconds, about 30 seconds to about 25 minutes, about 30 seconds to about 20 minutes, about 30 seconds to about 10 minutes, about 30 seconds to about 5 minutes, about 30 seconds to about 1 minute, about 1 minute to about 25 minutes, about 1 minute to about 20 minutes, about 1 minute to about 10 minutes, about 1 minute to about 5 minutes, about 5 minutes to about 25 minutes, about 5 minutes to about 20 minutes, about 5 minutes to about 10 minutes, about 10 minutes to about 25 minutes, 10 minutes to about 20 minutes, or about 20 minutes to about 25 minutes.

In some embodiments, the process further comprises freezing the protein source prior to the grinding of step i). In some embodiments, the process further comprises freezing the protein source after the grinding of step i). In some embodiments, the process further comprises freezing the protein source during the grinding of step i). In some embodiments, the freezing is performed using a flash-freezing process.

In some embodiments, the mixing of step ii) is performed after the grinding of step i). In some embodiments, the mixing of step ii) is performed simultaneously with the mixing of step i).

In some embodiments, the process further comprises:

iii) extruding the composition formed in step ii) into an outer casing adapted to contain the composition within the casing.

In some embodiments, the outer casing is selected from the group consisting of a sausage casing, a bucket, and a bag. In some embodiments, the outer casing is a perforated sausage casing or a perforated bag (e.g., a mesh bag). In some embodiments, the outer casing is a sausage casing. In some embodiments, the outer casing is a perforated sausage casing.

In some embodiments, the protein source has not been frozen prior to the grinding of step i). In some embodiments, the protein source is a dead-on-arrival (i.e., DOA) protein source. In some embodiments, the protein source is a dead-on-arrival protein source, wherein the death occurred during transportation from a farm to the processing plant. In some embodiments, the protein source is a food processing by-product (e.g., a meat processing by-product) which has not been frozen prior to the grinding of step i).

In some embodiments, the protein source has been frozen prior to the grinding of step i). In some embodiments, the process provided herein further comprises the step of unfreezing the protein source prior to performing the grinding of step i).

The present application also provides a process comprising:

i) freezing a protein source in a freezer apparatus; and

ii) grinding the protein source in a grinding apparatus to form a ground protein source, thereby forming the composition provided herein.

In some embodiments, the process further comprises:

iii) mixing the ground protein source with a preservative, a binding agent, an attractant, a pH balancing agent, or any combination thereof, thereby forming the composition provided herein.

In some embodiments, the process further comprises the step of unfreezing the protein source prior to performing the grinding of step ii).

In some embodiments, the process further comprises:

iv) extruding the composition formed in step iii) into an outer casing adapted to contain the composition within the casing. In some embodiments, the outer casing is selected from the group consisting of a sausage casing, a bucket, and a bag. In some embodiments, the outer casing is a sausage casing. In some embodiments, the outer casing is a perforated sausage casing or a perforated bag (e.g., a mesh bag). In some embodiments, the outer casing is a perforated sausage casing.

In some embodiments, the protein source comprises a protein selected from the group consisting of poultry, beef, swine, seafood, a food processing by-product, grocery store waste product, restaurant waste product, or any combination thereof.

In some embodiments, the protein source comprises poultry, for example, chicken, turkey, water-fowl (e.g., duck, goose, and the like), or any combination thereof. In some embodiments, the protein source comprises chicken, turkey, water-fowl, or any combination thereof.

In some embodiments, the protein source comprises poultry which has not been plucked, skinned, de-feathered, de-boned, rendered, or any combination thereof. In some embodiments, the protein source comprises the entire poultry (e.g., the entire chicken, including for example, feathers, bones, beak, muscles, organs, cartilage, tendons, ligaments, and the like).

In some embodiments, the protein source is a farm mortality protein source. In some embodiments, the farm mortality protein source is selected from the group consisting of poultry farm mortality, beef farm mortality, swine farm mortality, or any combination thereof. In some embodiments, the protein source is a ground farm mortality protein source (e.g., ground poultry farm mortality, for example, ground chicken farm mortality, ground turkey farm mortality, and the like).

In some embodiments, the protein source provided herein has been frozen for about 1 day to about 12 weeks, for example, about 1 day to about 8 weeks, about 1 day to about 4 weeks, about 1 day to about 2 weeks, about 1 day to about 1 week, about 1 week to about 8 weeks, about 1 week to about 4 weeks, about 1 week to about 2 weeks, about 2 weeks to about 12 weeks, about 2 weeks to about 8 weeks, about 2 weeks to about 4 weeks, about 4 weeks to about 12 weeks, about 4 weeks to about 8 weeks, or about 8 weeks to about 12 weeks prior to performing a process provided herein.

In some embodiments, the grinding step of the processes provided herein is performed at about room temperature. In some embodiments, each step of a process provided herein is performed at room temperature.

In some embodiments, the process further comprises transporting the frozen protein source from the freezer apparatus to a processing center. In some embodiments, the freezer apparatus is not located at the location of the processing center. In some embodiments, the freezer apparatus is located at a farm. In some embodiments, the freezer apparatus is adapted to freeze and contain a protein source located at the farm (e.g., poultry, beef, swine, and the like).

In some embodiments, the process does not comprise:

a) plucking the protein source prior to grinding;

b) skinning the protein source prior to grinding;

c) de-feathering the protein source prior to grinding;

d) de-boning the protein source prior to grinding;

e) rendering the protein source prior to grinding;

f) fermenting the protein source prior to grinding;

g) cooking the protein source prior to grinding;

or any combination of a)-g).

As will be appreciated, the compositions provided herein can be prepared using known grinding and mixing techniques and can be prepared according to any of numerous possible grinding and mixing methodologies. In some embodiments, the ground protein source is prepared using a grinding apparatus with a grinding cut of about 1 inch to about 2 inches.

### Methods of Use

The present application further provides methods of improving biosecurity in an environment (e.g., a farm). As used herein, the term “biosecurity” refers to procedures intended to protect humans and/or animals against disease or harmful biological agents in an environment. In some embodiments, the environment is selected from the group consisting of a farm (e.g., a farm uninfected with a disease or harmful biological agent; a farm within close proximity to a farm or water source infected with a disease or harmful biological agent), a water source (e.g., a lake, a river, a creek, and the like which are unaffected with a disease or harmful biological agent), and a processing plant (e.g., a plant or facility which processes protein sources such as farm livestock).

In some embodiments, the biosecurity of the environment is improved by removing a deceased protein source (e.g., a deceased farm animal) from the environment (e.g., from a farm). In some embodiments, the biosecurity of the environment is improved by removing a deceased protein source (e.g., a deceased farm animal) from the environment (e.g., from a farm) and placing it in a sealed container. In some embodiments, the sealed container is a sealed freezer container. In some embodiments, the sealed freezer container prevents scavengers and/or insects from accessing the deceased protein source, thereby improving the biosecurity of the surrounding environment. In some embodiments, the sealed freezer unit prevents the spread of pathogens, microbes, and/or other microorganisms on or within the deceased farm animal, thereby improving the biosecurity of the surrounding environment.

In some embodiments, improving the biosecurity of an environment (e.g., a farm) comprises reducing the amount of scavengers and/or insects attracted to the environment (e.g., a farm). In some embodiments, improving the biosecurity of an environment comprises reducing the amount of disease carrying scavengers (e.g., raccoons, foxes, migratory waterfowl, and the like that may carry, for example, avian influenza) and/or disease carrying insects (e.g., mosquitos, flies, and the like), that are attracted to the environment.

Accordingly, the present application provides a method of improving biosecurity in a first environment (e.g. a farm), comprising:

i) freezing a protein source (e.g., a deceased farm animal such as a poultry farm mortality in a freezer apparatus located at the farm) in a freezer located at the first environment to be improved (e.g. a freezer apparatus located at a farm);

ii) transporting the frozen protein source from the first environment (e.g., from a farm) to a second environment (e.g., a processing center);

iii) grinding the protein source in a grinding apparatus at the second environment (e.g. a processing center) to form a ground protein source; and

iv) mixing the ground protein source with a preservative, a binding agent, an attractant, a pH balancing agent, or any combination thereof, thereby forming a composition provided herein.

In some embodiments, the method is a method of improving biosecurity of a farm, comprising:

i) freezing a farm animal protein source (e.g., poultry, beef, swine, and the like) in a freezer apparatus located at the farm;

ii) transporting the protein source from the farm to a processing center;

iii) grinding the protein source in a grinding apparatus at the processing center to form a ground protein source; and

iv) mixing the ground protein source with a preservative, a binding agent, an attractant, a pH balancing agent, or any combination thereof, thereby forming a composition provided herein.

In some embodiments, the method is a method of improving biosecurity of a farm, comprising:

i) freezing a deceased farm animal (e.g., a farm mortality animal such as poultry, beef, swine, etc.) in a freezer apparatus located at the farm;

ii) transporting the deceased farm animal from the farm to a processing center;

iii) grinding the deceased farm animal in a grinding apparatus at the processing center to form a ground farm animal (e.g., ground poultry, ground beef, ground swine, and the like); and

iv) mixing the ground farm animal with a preservative, a binding agent, an attractant, a pH balancing agent, or any combination thereof, thereby forming a composition provided herein.

In some embodiments, the method is a method of improving biosecurity of a farm, comprising:

i) freezing deceased poultry in a freezer apparatus located at the farm;

ii) transporting the deceased poultry from the farm to a processing center;

iii) grinding the deceased poultry in a grinding apparatus at the processing center to form ground poultry; and

iv) mixing the ground poultry with a preservative, a binding agent, an attractant, a pH balancing agent, or any combination thereof, thereby forming a composition provided herein.

In some embodiments, the methods of improving biosecurity provided herein further comprise segregating the protein source (e.g., poultry farm mortality) in a sealed container (e.g. a sealed freezer container) prior to freezing the protein source. In some embodiments, segregating the protein source (e.g., poultry farm mortality) in a sealed container (e.g., a sealed freezer container) reduces and/or prevents access to the protein source by scavengers and insects, thereby improving the biosecurity of the first environment (e.g., a farm). In some embodiments, segregating the protein source (e.g., poultry farm mortality) in a sealed container (e.g., a sealed freezer container) reduces scavengers and insects (e.g., disease carrying scavenger and/or disease carrying insects) in the first environment, thereby improving the biosecurity of the first environment (e.g., a farm).

In some embodiments, the deceased farm animal (e.g., the deceased poultry) is a farm mortality farm animal (e.g., a poultry farm mortality).

In some embodiments, the protein source (e.g. the farm animal) is removed from the freezer apparatus prior to transporting to the processing center. In some embodiments, the protein source (e.g. the farm animal) remains inside the freezer apparatus while being transported to the processing center.

The present application further provides methods of attracting fish, crustacean, or other aquatic life, or a combination thereof. In some embodiments, the method comprises contacting a composition provided herein with a body of water containing said fish, crustacean, or a combination thereof. In some embodiments, the method comprises contacting a fishing trap comprising a composition provided herein with a body of water containing said fish, crustacean, or a combination thereof.

In some embodiments, the body of water is selected from the group consisting of an ocean, a bay, a lake, a river, and a creek. In some embodiments, the body of water is an ocean. In some embodiments, the composition is submerged in the body of water.

In some embodiments, the composition provided herein is identified by the fish, crustacean, or a combination thereof, as a food source, thereby attracting the fish, crustacean, or a combination thereof.

In some embodiments, the method further comprises waiting a time sufficient to attract the fish, for example, about 1 minute to about 1 week, about 1 minute to about 5 days, about 1 minute to about 2 days, about 1 minute to about 1 day, about 1 minute to about 12 hours, about 1 minute to about 6 hours, about 1 minute to about 2 hours, about 1 minute to about 1 hour, about 1 hour to about 1 week, about 1 hour to about 5 days, about 1 hour to about 2 days, about 1 hour to about 1 day, about 1 hour to about 12 hours, about 1 hour to about 6 hours, about 1 hour to about 2 hours, about 2 hours to about 1 week, about 2 hours to about 5 days, about 2 hours to about 2 days, about 2 hours to about 1 day, about 2 hours to about 12 hours, about 2 hours to about 6 hours, about 6 hours to about 1 week, about 6 hours to about 5 days, about 6 hours to about 2 days, about 6 hours to about 1 day, about 6 hours to about 12 hours, about 12 hours to about 1 week, about 12 hours to about 5 days, about 12 hours to about 2 days, about 12 hours to about 1 day, about 1 day to about 1 week, about 1 day to about 5 days, about 1 day to about 2 days, about 2 days to about 1 week, about 2 days to about 5 days, or about 5 days to about 1 week,

In some embodiments, the method further comprises catching the attracted fish with a fishing trap or a fishing net or line. In some embodiments, the method comprises contacting a composition provided herein with a body of water containing said fish, crustacean, or a combination thereof, thereby attracting said fish, crustacean, or combination thereof, and subsequently contacting the body of water with a fishing trap or fishing net or line to catch the attracted fish.

In some embodiments, the composition is attached to a fishing trap or fishing net or line. In some embodiments, the composition is attached to an outer surface of the fishing trap. In some embodiments, the composition is attached to an inner surface of the fishing trap. In some embodiments, the composition is contained within a fishing trap. In some embodiments, the composition is not attached to the fishing trap. In some embodiments, the composition is not contained within the fishing trap. In some embodiments, the composition is not attached to the fishing net or line.

In some embodiments, the fish is a bottom feeder fish. In some embodiments, the fish is an eel. In some embodiments, the crustacean is a bottom feeder crustacean. In some embodiments, the crustacean is selected from the group consisting of crab (e.g., blue crab), conch, lobster, crawfish, shrimp, or any combination thereof.

The terms “bottom feeder fish” and “bottom feeder crustacean” are readily understood by one skilled in the art.

### Kits

The present application further provides a kit comprising a bait composition provided herein and instructions for using the bait composition.

In some embodiments, the kit comprises one or more components of the composition provided herein (e.g., a protein source, a preservative, a binding agent, an attractant, and/or a pH balancing agent as provided herein). For example, the components can be separately packaged, contained, or premixed. In some embodiments, the kit further comprises instructions for mixing the components of the kit to form a composition provided herein. In some embodiments, the composition is pre-packaged in a container. In some embodiments, the composition is pre-packaged in a container or outer casing as described herein (e.g., a mesh bag and/or a sausage casing).

In some embodiments, the kit comprises:

i) a composition provided herein;

ii) a fishing trap; and

iii) instructions for performing a method provided herein.

In some embodiments, the fishing trap is configured for trapping fish. In some embodiments, the fishing trap is configured for trapping crustaceans. In some embodiments, the fishing trap is configured for catching a fish or crustacean selected from the group consisting of crab (e.g. blue crab), conch, lobster, crawfish, shrimp, eel, or any combination thereof.

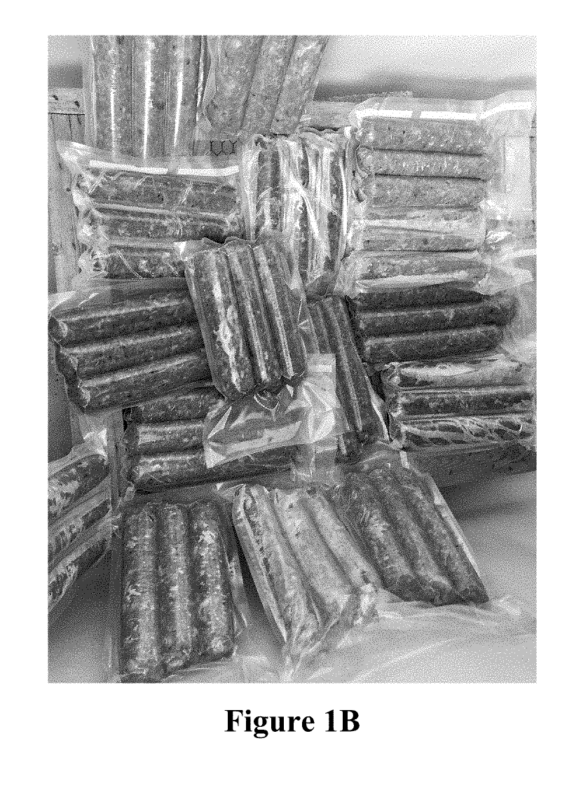

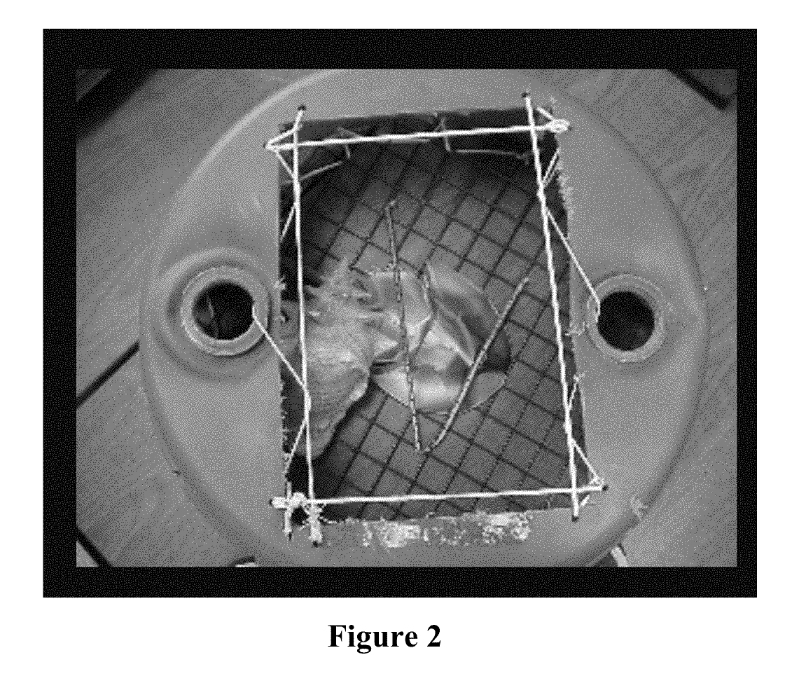

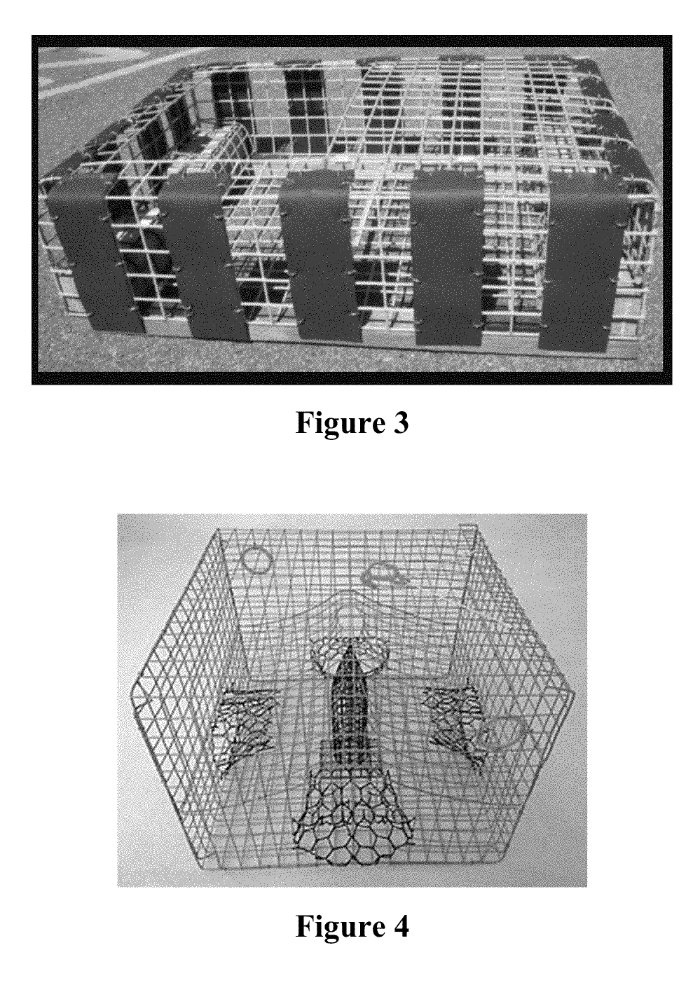

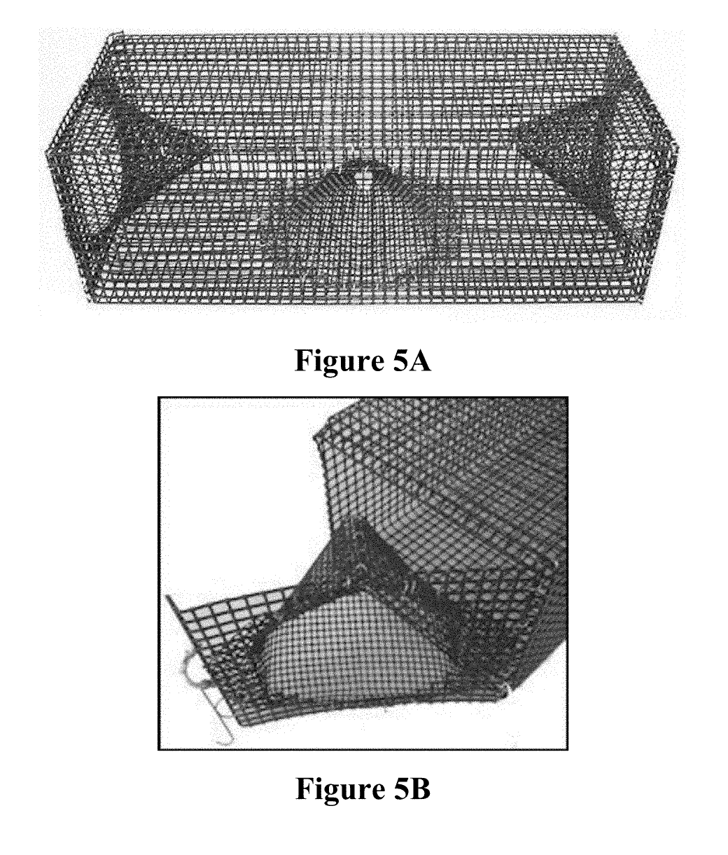

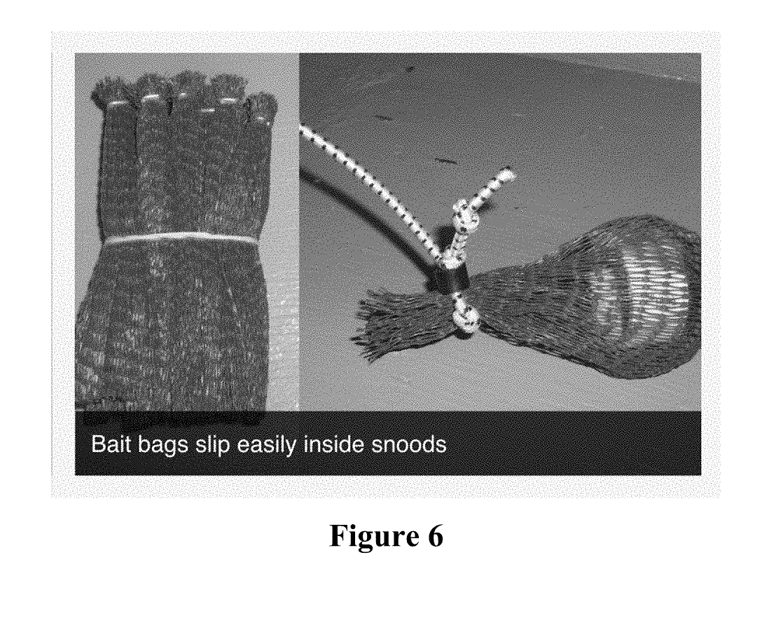

In some embodiments, the fishing trap is configured substantially as shown in FIG. 2. In some embodiments, the fishing trap is configured substantially as shown in FIG. 3. In some embodiments, the fishing trap is configured substantially as shown in FIG. 4. In some embodiments, the fishing trap is configured substantially as shown in FIG. 5A. In some embodiments, the fishing trap is configured substantially as shown in FIG. 5B. In some embodiments, the fishing trap is configured substantially as shown in FIG. 6.

### EXAMPLES

The following examples are offered for illustrative purposes, and are not intended to limit the invention.

### Example 1. Representative Bait Composition

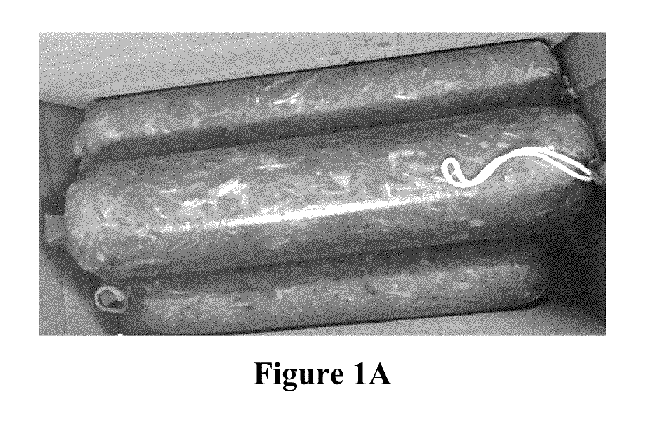

Representative bait compositions, encased in sausage casings are shown in FIGS. 1A-1B. The bait compositions were prepared according to the following general procedure: As part of standard operating procedure on a poultry farm, the grower walks the chicken houses each morning collecting the routine poultry farm mortality (i.e., the normal number of chickens that died of natural causes over the previous 24-hour period) and then securely stores the dead birds inside a freezer collection unit.

Next, live birds are caught at the end of the flock's growing cycle, and a forklift is used to remove and empty the bottom bins of each of the freezer collection units into the back of an offal hauling trailer. The frozen and/or tempered deadstock is then combined with deadstock collected from other farms that day and delivered to a processing facility that day where the poultry is subsequently ground and then mixed with one or more components (e.g., a preservative, a binding agent, an attractant, a pH balancing agent, or any combination thereof). The mixture is then extruded through a machine into pre-perforated sausage casings. The filled casing is then clipped and sealed shut at regular intervals to form 1 lb. to 1.75 lb. chubs, which are then packaged inside a carton or wax cardboard box. The cartons of chubs are then stored inside a freezer unit until shipment to either a bait broker or the end-user waterman.

### Example 2. Experimental Testing—Blue Crab Fishing & Conch Fishing

Blue crab watermen and conch fishermen have experimentally tested representative bait compositions and reported catch sizes that were equal to or larger than the catch sizes they have acquired using standard fishing baits for those fisheries. The watermen also commented positively on the simplicity and ease of use of the packaging, the longevity of the bait composition in the aquatic environment and the reduced labor necessary for baiting the traps. The bait compositions provided herein have been shown to be useful when used in combination with fishing traps, for example, as shown in FIGS. 2-6.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular embodiment of the present invention can be combined with one or more of any of the other features of any other embodiments of the present application described herein, with modifications as appropriate to ensure compatibility of the combinations. Such combinations are considered to be part of the present application.

1. A composition, comprising a farm mortality protein source.

2. (canceled)

3. The composition of claim 1, wherein the farm mortality protein source is selected from the group consisting of poultry farm mortality, beef farm mortality, swine farm mortality, fish farm mortality, or any combination thereof.

4.-6. (canceled)

7. The composition of claim 1, wherein the farm mortality protein source has not been plucked, skinned, de-feathered, de-boned, rendered, cooked, or any combination thereof.

8. The composition of claim 1, wherein the farm mortality protein source is a ground farm mortality protein source.

9. The composition of claim 1, wherein the composition further comprises a preservative, a binding agent, an attractant, a pH balancing agent, an additional protein source, or any combination thereof.

10.-14. (canceled)

15. The composition of claim 1, further comprising an outer container adapted to contain the composition within the outer container.

16.-28. (canceled)

29. A process of preparing a composition of claim 1, comprising:
i) grinding the farm mortality protein source in a grinding apparatus to form a ground farm mortality protein source, thereby forming the composition.

30. The process of claim 29, further comprising:
ii) mixing the ground farm mortality protein source with an additional protein source, a preservative, a binding agent, an attractant, a pH balancing agent, or any combination thereof, thereby forming the composition.

31. The process of claim 29, further comprising:
iii) extruding the composition formed in step ii) into an outer container adapted to contain the composition within the outer container.

32.-40. (canceled)

41. The process of claim 29, wherein prior to the grinding of step i), the protein source has been frozen.

42. (canceled)

43. The process of claim 41, further comprising unfreezing the protein source prior to performing the grinding of step i).

44. The process of claim 29, wherein prior to the grinding of step i), the protein source has not been frozen.

45. A process, comprising:
i) freezing a farm mortality animal in a freezer apparatus; and
ii) grinding the farm mortality animal in a grinding apparatus to form a ground farm mortality animal, thereby forming the composition of claim 1.

46. The process of claim 45, further comprising:
iii) mixing the ground farm mortality animal with an additional protein source, a preservative, a binding agent, an attractant, a pH balancing agent, or any combination thereof, thereby forming the composition.

47. The process of claim 45, further comprising the step of unfreezing the farm mortality animal prior to performing the grinding of step ii).

48.-59. (canceled)

60. A method of improving biosecurity on a farm, comprising:
i) freezing poultry farm mortality in a freezer located at the farm;
ii) transporting the frozen poultry farm mortality from the farm to a processing center; and
iii) grinding the poultry farm mortality in a grinding apparatus at the processing center to form a composition of claim 1, thereby improving the biosecurity of the farm.

61. The process of claim 60, further comprising:
iv) mixing the ground protein source with an additional protein source, a preservative, a binding agent, an attractant, a pH balancing agent, or any combination thereof, thereby forming the composition of claim 9.

62. A method of attracting a fish, a conch, a crustacean, or any combination thereof, comprising contacting the composition of claim 1, with a body of water containing said fish, conch, crustacean, or any combination thereof.

63.-67. (canceled)

68. The method of claim 62, wherein the fish is a bottom feeder fish, bottom feeder conch, or a bottom feeder crustacean.

69. The method of claim 62, wherein the method is a method of attracting crab, conch, lobster, crawfish, eel, shrimp, or any combination thereof.
